(19) United States
(12) Patent Application Publication
(10) Pub. No.: US 2026/0075309 A1
(43) Pub. Date: Mar. 12, 2026

(54) Adaptive GenAI-Powered Camera or Device Configuration System

(71) Applicant: ZEBRA TECHNOLOGIES CORPORATION, Lincolnshire, IL (US)

(72) Inventor: Michel Doyon, Lachine (CA)

(21) Appl. No.: 18/826,398

(22) Filed: Sep. 6, 2024

(51) Int. Cl. H04N 23/60; G06F 40/40; H04N 23/661; H04N 23/90

(52) U.S. Cl. CPC H04N 23/64; G06F 40/40; H04N 23/661; H04N 23/90

(57) ABSTRACT

Systems and methods for controlling an imaging device described herein may include receiving, at a trained machine learning model from an imaging device, an operating parameter description file; receiving, by one or more processors, a natural language prompt to control the imaging device; generating, by processing a natural language query entered into the natural language prompt and the description file and using the trained machine learning model, a set of executable code corresponding to the natural language prompt for configuring the imaging device operating parameters; transmitting, by the one or more processors, the set of executable code to the imaging device to cause the imaging device to execute the set of executable code to generate an output; and causing, by the one or more processors, the output to be displayed in an output device.

### TECHNICAL FIELD

The present disclosure is generally directed to methods and systems for using machine learning models for configuring and controlling imaging devices.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Imaging devices, such as those used in machine vision applications, include many settings (e.g., operation parameters) that can be adjusted to meet the needs of a particular machine vision application. For example, settings such as exposure, an aperture opening, etc. may be adjusted to capture images that fit the needs of a particular application. However, the multitude of settings makes adjusting the settings of an imaging device to achieve a desired image difficult. Moreover, different imaging devices may have different settings, or may use different naming conventions for the same setting, further increasing the difficulty of adjusting image device settings. Thus, there exists an opportunity for controlling image devices with machine learning and generative artificial intelligence.

### BRIEF SUMMARY

In one aspect, a method for controlling an imaging device includes receiving, at a trained machine learning model from an imaging device, an operating parameter description file; receiving, by one or more processors, a natural language prompt to control the imaging device; generating, by processing a natural language query entered into the natural language prompt and the description file and using the trained machine learning model, a set of executable code corresponding to the natural language prompt for configuring the imaging device operating parameters; transmitting, by the one or more processors, the set of executable code to the imaging device to cause the imaging device to execute the set of executable code to generate an output; and causing, by the one or more processors, the output to be displayed in an output device.

### BRIEF DESCRIPTION OF THE FIGURES

The figures described below depict various implementations of the system and methods disclosed therein. It should be understood that each figure depicts one implementation of a particular implementation of the disclosed system and methods, and that each of the figures is intended to accord with a possible implementation thereof. Further, wherever possible, the following description refers to the reference numerals included in the following figures, in which features depicted in multiple figures are designated with consistent reference numerals.

The figures depict preferred implementations for purposes of illustration only. One skilled in the art will readily recognize from the following discussion that alternative implementations of the systems and methods illustrated herein may be employed without departing from the principles of the invention described herein.

FIG. 1 depicts an example environment in which systems and devices imaging devices may be utilized, in accordance with embodiments described herein.

FIG. 2 is a block diagram representative of an example logic circuit capable of implementing example methods and/or operations described herein.

FIG. 3 is a block diagram of an example logic circuit for implementing example methods and/or operations described herein.

FIG. 4 is a flow diagram for example machine learning model training and operation, in accordance with embodiments described herein.

FIG. 5 is a flow diagram of an example method for controlling an imaging device with generative artificial intelligence, in accordance with embodiments described herein.

### DETAILED DESCRIPTION

### Overview

The present techniques provide systems and methods using machine learning for, inter alia, controlling an imaging device. The methods and systems include, for example, receiving, at a trained machine learning model from an imaging device, an operating parameter description file; receiving a natural language prompt to control the imaging device; generating, by processing a natural language query entered into the natural language prompt and the description file and using the trained machine learning model, a set of executable code corresponding to the natural language prompt for configuring the imaging device operating parameters; transmitting the set of executable code to the imaging device to cause the imaging device to execute the set of executable code to generate an output; and causing, by the one or more processors, the output to be displayed in an output device.

As described above, imaging devices may include a multitude of operating parameters, such that selecting which operating parameters to select to achieve a desired image may be difficult. Moreover, different imaging devices may include different operating parameters or may use different naming conventions for the same operating parameter. Currently, a user must manually adjust the settings of different devices.

To overcome these technical hurdles, the present application describes systems and methods that utilize machine learning to generate code that controls imaging devices. The techniques of the present disclosure provide a technical improvement over conventional techniques at least by improving the functionality of a computing device (e.g., server executing the machine learning model). In particular, the machine learning model can generate instructions for any computing device, enhancing efficiency of the computing system as only one machine learning model must be trained to generate executable code for any imaging device in the system, rather than needing a machine learning model for each type of imaging device in the system. Additionally, efficiency is improved because the machine learning model can determine which combination of settings will best achieve a desired image, reducing repeatedly generating and executing code to capture the desired image. The present disclosure describes improvements in the functioning of the computer itself because the computing device more efficiently controls imaging devices as a direct result of the generation of code by the machine learning model.

### Example Environment

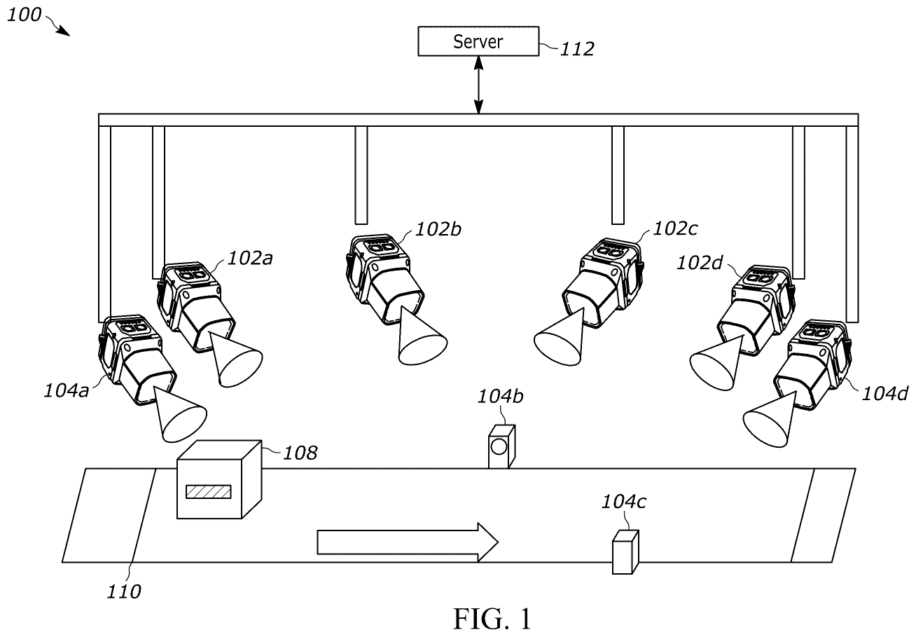

FIG. 1 depicts an example environment 100 in which imaging devices may be utilized, in accordance with embodiments described herein. The example environment 100 may generally be an industrial setting that includes different sets of imaging devices 102/104 positioned over or around a conveyor belt 106. The imaging devices 102 may be machine vision cameras each positioned at a different location along the conveyor belt 106 and each having a different orientation relative to the conveyor belt 106, where the machine vision cameras 102 are configured to capture image data over a corresponding field of view. The imaging devices 102 may be 3D image devices, such as 3D cameras that capture a 3D image data of an environment. Collectively, the 3D imaging devices 102 may form a three-dimensional (3D) data acquisition subsystem of the environment 100. Example, 3D imaging devices herein include time-of-flight 3D cameras where the 3D image data captured is a map of distances of objects to the camera, structure light 3D cameras where one device projects a typically non-visible pattern on objects and an offset camera captures the pattern where each point in the pattern is shifted by an amount indicative of the objects upon which the point falls, or a virtual 3D camera where, for example, 2D image data is captured and passed through a trained neural network or other image processor to generate a 3D scene from the 2D image data.

The imaging devices 104 may be 2D imagers, such as 2D color imagers or 2D grayscale imagers, each configured to capture 2D image data of a corresponding field of view. Imaging devices 104 are 2D imagers that can be configured to capture image data of a target object 108 on a conveyor belt 106. The belt 106 may carry a target object 108 across an entry point 110 where a set of initial imaging devices 102 and 104 are located. A server 112 may be communicatively coupled to each of the imaging devices 102 and 104, so that the server 112 may configure and control the imaging device 102 and 104 capture images of the object 108 along the conveyor belt 106. The captured images may be further analyzed by the server 112.

The set of imaging devices 102 and 104 may be organized in an array or other manner that allows capturing images along the entire working length of a belt 106 and may be arranged in a leader/follower configuration with a leader device (not shown), that may be configured to trigger the machine vision cameras 104 to capture 3D image data of the target object 108, organize results from each machine vision camera's image capture/inspection, and transmit the results and/or the captured images to the server 112. Each imager of the imaging devices 102 and 104 stores a program for execution (e.g., a “job,” “executable code”) that includes information regarding the respective imagers image-capture parameters, such as focus, exposure, gain, specifics on the type of symbology targeted for decoding, or specific machine vision inspection steps.

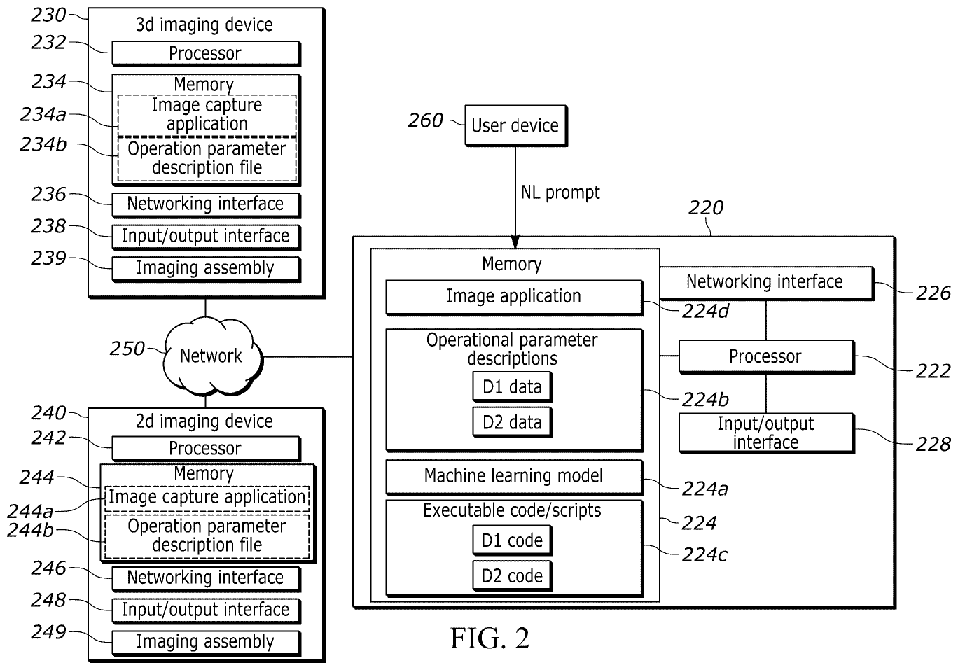

In operation, the imaging devices 102 and 104 transmit a description of their operating parameters, which may be in the form of an XML file, to the server 112. In some embodiments, the description of the operating parameters may be a JSON file. In some embodiments, the description of the operating parameters may include more than one file. In some embodiments, the imaging devices 102 and 104 may transmit a string identifying the device (e.g., serial number, product ID) to the server 112, which the server may use to retrieve operation parameters for the imaging devices 102 and 104 from the cloud and/or from an imaging device manufacturer computer system. The server 112 may receive a natural language prompt from a user device (e.g., text input from a keyboard, audio input from a microphone), such as the user device 260 in FIG. 2, and generate a program for the imaging devices 102 and 104 to execute. The program may configure operating parameters of the imaging device 102 and 104 and include instructions to capture image data of an object 108 on the conveyor belt 106. The image devices 102 and 104 may transmit the image data of the object 108 for display and/or further analysis to the server 112.

It should be appreciated that, while one machine vision camera 102a and one 2D imaging device 104a are shown, any suitable number of devices may be used in order to capture all images of the target object 108, take multiple image captures of the target object 108, and/or otherwise capture sufficient image data of the target object 108.

### Example Processing Platform

FIG. 2 is a block diagram representative of an example logic circuit capable of implementing example methods and/or operations described herein. As an example, the example logic circuit may be capable of implementing one or more components of FIGS. 1-4.

The example logic circuit of FIG. 2 is a processing platform 220 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs). In an example, the processing platform 220 is implemented at the server 112 in FIG. 1.

The example processing platform 220 of FIG. 2 includes a processor 222 such as, for example, one or more microprocessors, controllers, and/or any suitable type of processor. The example processing platform 220 of FIG. 2 includes memory (e.g., volatile memory, non-volatile memory) 224 accessible by the processor 222 (e.g., via a memory controller). The example processor 222 interacts with the memory 224 to obtain, for example, machine-readable instructions stored in the memory 224 corresponding to, for example, the operations represented by the flowcharts of this disclosure.

The memory 224 includes a machine learning model 224a, operational parameter descriptions 224b, executable code/scripts 224c, and image application 224d that are accessible by the example processor 222. The machine learning model 224a may comprise a suitable algorithm architecture or combination thereof configured to, for example, perform image device configuration. In some aspects, the machine learning methods and algorithms may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented machine learning methods and algorithms are directed toward at least one of a plurality of categorizations of machine learning, such as supervised learning, unsupervised learning, and reinforcement learning. In some aspects, the machine learning model may be a generative model, a large language model (LLM), and/or a multimodal machine learning model. To illustrate, the example processor 222 may access the memory 224 to use the machine learning model 224a to generate executable code/scripts 224c for controlling the imaging devices 230 and 240. Additionally, or alternatively, machine-readable instructions corresponding to the example operations described herein may be stored on one or more removable media (e.g., a compact disc, a digital versatile disc, removable flash memory, etc.) that may be coupled to the processing platform 220 to provide access to the machine-readable instructions stored thereon. In some embodiments, some or all of the machine learning model 224a may be implemented at the imaging devices 230 and/or 240. For example, in some embodiments, a prompt may be input directly into an imaging device 230 or 240 (e.g., via the I/O interfaces 236 or 246, respectively, and/or the user device 260) such that some or all of the processes of the machine learning model 224a occur at the imaging device 230 or 240, respectively. In some embodiments, some or all of the processes of the machine learning model 224a may occur in the cloud.

The operational parameter descriptions 224b may include data describing the operation parameters of the imaging device 230 (e.g., D1 data) and data describing the operation parameters of the imaging device 240 (e.g., D2 data). The processing platform 220 may receive the operational parameter descriptions 224b from the imaging devices 230, 240 (e.g., the processing platform 220 may receive the operation parameter description files 234b, 244b from imaging devices 230, 240, respectively, and store them as operational parameter descriptions 224b in the memory 224 of processing platform 220).

The executable code/scripts 224c may be executable code generated by the machine learning model 224a. The executable code/scripts 224c may include code/scripts for imaging device 230 (e.g., D1 code) and code/scripts for imaging device 240 (e.g., D2 code). The code that is generated for an imaging device 230 may be different from the code that is generated for an imaging device 240. For example, the D1 code may be different from D2 code due to the imaging devices 230 and 240 having different operating parameters or needing different instructions to achieve a result. In another example, a prompt received from the user device 260 may include a query and/or request for both imaging devices 230 and 240, which may result in a different set of code/script for each of the imaging devices 230 and 240. The executable code/scripts 224c may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

The image application 224d may include and/or otherwise comprise executable instructions (e.g., via the one or more processors 222) that allow a user to configure a machine vision job and/or imaging settings of the imaging devices 230 and 240. For example, the application 224d may render a graphical user interface (GUI) on a display (e.g., I/O interface 228) or a connected device, and the user may interact with the GUI to change various settings, modify machine vision jobs, input data, tracking parameters, location data and orientation data for the imaging devices, operating parameters of a conveyor belt, etc. The application 224d may further render an output image resulting from the execution of a set of code by an imaging device 230 and/or 240, and/or render a summary of executed code to be displayed on a display or connected device. For example, the application 224d may render a status, such as temperature, of an imaging device 230 on a display or connected device.

The example processing platform 220 of FIG. 2B also includes a networking interface 226 to enable communication with other machines via, for example, one or more networks. The example networking interface 226 includes any suitable type of communication interface(s) (e.g., wired and/or wireless interfaces) configured to operate in accordance with any suitable protocol(s) (e.g., Ethernet for wired communications and/or IEEE 802.11 for wireless communications).

The example processing platform 220 of FIG. 2B also includes input/output (I/O) interfaces 228 to enable receipt of user input and communication of output data to the user. Such user input and communication may include, for example, any number of keyboards, mice, USB drives, optical drives, screens, touchscreens, etc.

The example processing platform 220 is connected to a 3D imaging device 230 configured to capture 3D image data of target objects (e.g., target object 108), 2D imaging device 240 configured to capture 2D image data of target objects (e.g., target object 108) in particular 2D image data of barcodes on target objects, and a user device 260 configured to receive input from a user and display output from the processing platform 220. The imaging devices 230 and 240 and user device 260 may be communicatively coupled to the platform 220 through a network 250.

The 3D imaging device 230 may be or include machine vision cameras 102a-d, and may further include one or more processors 232, one or more memories 234, a networking interface 236, an I/O interface 238, and an imaging assembly 239. The 3D imaging device 230 may include an image capture application 234a and an operation parameter description file 234b, e.g., a file describing parameters of the 3D imaging device 230. The operation parameter description file 224b may be an XML file or a JSON file. In some embodiments, there may be more than one operating parameter description file.

The 2D imaging device 240 may be or include imaging devices 104a-d, and may further include one or more processors 242, one or more memories 244, a networking interface 246, an I/O interface 248, and an imaging assembly 249. The 2D imaging device 240 may also include an image capture application 244a and an operation parameter description file 244b.

Each of the imaging devices 230, 240 may include flash memory used for determining, storing, or otherwise processing imaging data/datasets and/or post-imaging data. The imaging device 230, 240 may then receive, recognize, and/or otherwise interpret a trigger that causes them to capture an image of a target object (e.g., target object 108) in accordance with the configuration established via one or more job scripts. Once captured and/or analyzed, the imaging device 230, 240 may transmit the images and any associated data across the network 250 to the processing platform 220 for further analysis, display, and/or storage in accordance with the methods herein. In various embodiments, the imaging device 230, 240 are “thin” camera devices that capture respective 3D and 2D image data and offload them to the processing platform 220 for processing, without further processing at the imaging device. In various other embodiments, the imaging devices 230, 240 may be “smart” cameras and/or may otherwise be configured to automatically perform sufficient imaging processing functionality to implement all or portions of the methods described herein.

The imaging assemblies 239, 249 may include a digital camera and/or digital video camera for capturing or taking digital images and/or frames. Each digital image may comprise pixel data that may be analyzed in accordance with instructions, as executed by the one or more processors 232, 234, as described herein. The digital camera and/or digital video camera of, for example, the imaging assembly 239 may be configured to take, capture, or otherwise generate 3D digital images and, at least in some embodiments, may store such images in the one or more memories 234. In some examples, the imaging assembly 239 captures a series of 2D images that are processed to generate 3D images, where such processing may occur at the 3D imaging device 230 using an imaging processing application (not shown) or at the processing platform 220 in a processing application 224d. The imaging assembly 249 is configured to take, capture, or otherwise generate 2D digital images that may be stored in the one or more memories 244.

The imaging assembly 240 may include a photo-realistic camera (not shown) or other 2D imager for capturing, sensing, or scanning 2D image data. The photo-realistic camera may be an RGB (red, green, blue) based camera for capturing 2D images having RGB-based pixel data. In various embodiments, the imaging assembly 230 include a 3D camera (not shown) for capturing, sensing, or scanning 3D image data. The 3D camera may include an Infra-Red (IR) projector and a related IR camera for capturing, sensing, or scanning 3D image data/datasets.

Each of the one or more memories 224, 234, and 244 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., the image capture application 234a, the image capture application 244a, the image application 224d, the machine learning model 224a, and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 222, 232, and 242 (e.g., working in connection with the respective operating system in the one or more memories 224, 234, and 244) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

The one or more memories 224, 234, and 244 may store an operating system (OS) (e.g., Microsoft Windows, Linux, Unix, etc.) capable of facilitating the functionalities, apps, methods, or other software as discussed herein. Additionally, or alternatively, the image capture application 234a, the image capture application 244b, imaging processing application 224d, and machine learning model 224a may also be stored in an external database (not shown), which is accessible or otherwise communicatively coupled to the processing platform 220 via the network 130. The one or more memories 224, 234, and 244 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision based imaging application, configured to facilitate various functionalities discussed herein. It should be appreciated that one or more other applications may be envisioned and that are executed by the one or more processors 122a, 124a, 126a.

The one or more processors 222, 232, 242 may be connected to the one or more memories 224, 234, 244 via a computer bus responsible for transmitting electronic data, data packets, or otherwise electronic signals to and from the one or more processors 222, 232, 242 and one or more memories 224, 234, 244 in order to implement or perform the machine readable instructions, methods, processes, elements or limitations, as illustrated, depicted, or described for the various flowcharts, illustrations, diagrams, figures, and/or other disclosure herein.

The one or more processors 222, 232, 242 may interface with the one or more memories 224, 234, 244 via the computer bus to execute the operating system (OS). The one or more processors 222, 232, 242 may also interface with the one or more memories 224, 234, 244 via the computer bus to create, read, update, delete, or otherwise access or interact with the data stored in the one or more memories 224, 234, 244 and/or external databases (e.g., a relational database, such as Oracle, DB2, MySQL, or a NoSQL based database, such as MongoDB). The data stored in the one or more memories 224, 234, 244 and/or an external database may include all or part of any of the data or information described herein, including, for example, image data from images captures by the imaging assemblies 239, 249, and/or other suitable information.

The networking interfaces 226, 236, 246 may be configured to communicate (e.g., send and receive) data via one or more external/network port(s) to one or more networks or local terminals, such as network 250, described herein. In some embodiments, networking interfaces 226, 236, 246 may include a client-server platform technology such as ASP.NET, Java J2EE, Ruby on Rails, Node.js, a web service or online API, responsive for receiving and responding to electronic requests. The networking interfaces 226, 236, 246 may implement the client-server platform technology that may interact, via the computer bus, with the one or more memories 224, 234, 244 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 226, 236, 246 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 250. In some embodiments, network 250 may comprise a private network or local area network (LAN). Additionally, or alternatively, network 250 may comprise a public network such as the Internet. In some embodiments, the network 250 may comprise routers, wireless switches, or other such wireless connection points communicating to the processing platform 220 (via the networking interface 226), the 3D imaging device 230 (via networking interface 236), and the 2D imaging device 240 (via networking interface 246) via wireless communications based on any one or more of various wireless standards, including by non-limiting example, IEEE 802.11a/b/c/g (WIFI), the BLUETOOTH standard, or the like.

The I/O interfaces 228, 238, 248 may include or implement operator interfaces on a user device 260 configured to present information to an administrator or operator and/or receive inputs from the administrator or operator. The I/O interfaces 228, 238, and 248 may include software and/or hardware to communicate (e.g., send and receive) data with the user device 260. The I/O interfaces 228, 238, 248 may also include I/O components (e.g., ports, capacitive or resistive touch sensitive input panels, keys, buttons, lights, LEDs, any number of keyboards, mice, USB drives, optical drives, screens, touchscreens, etc.), which may be directly accessible via the processing platform 220, the 3D imaging device 230, and/or the 2D imaging device 240. The I/O interfaces 228, 238, and 248 may interact with a.

The user device 260 may be any suitable device for communication, including one or more computers, mobile devices, wearables, smart watches, smart contact lenses, smart glasses, augmented reality glasses, virtual reality headsets, mixed or extended reality glasses or headsets, telephones, and/or other electronic or electrical components. The user device 260 may include an input component that a user/operator may use to input data to a processing platform 220. For example, a user may use the user device 260 to input a text and/or audio natural language prompt to the processing platform 220. The user device 260 may include an output component that a user/operator may use to visualize any images, graphics, text, data, features, pixels, and/or other suitable visualizations or information. For example, the processing platform 220, the 3D imaging device 230, and/or the 2D imaging device 240 may comprise, implement, have access to, render, or otherwise expose, at least in part, a graphical user interface (GUI) for displaying images, graphics, text, data, features, pixels, and/or other suitable visualizations or information on a user interface 260. The user device 260 may communicate with the processing platform 220 and the imaging devices 230 and 240 directly and/or via the network 250.

In operation, a processing platform 220 may receive operation parameter description file 234b and operation parameter description file 244b from an imaging device 230 and imaging device 240, respectively, and/or from the cloud, over LAN, or stored in memory 224. The operation parameter description files 234b, 244b may be stored as operational parameter descriptions 224b in the memory 224 of the processing platform 220. A user may interact with user device 260 to input a natural language prompt to the processing platform 220. The image application 224d may process the natural language prompt and input the natural language prompt and operational parameter descriptions 224b into a machine learning model 224a to generate executable code/scripts 224c, which may contain different sets of code/scripts for different imaging devices (e.g., D1 Code for imaging device 230 and D2 Code for imaging device 240). Some or all of the processes of the machine learning model 224a may occur on the cloud, in the processing platform 220, in the imaging devices 230 and/or 240, and/or on another device connected via LAN to the system of FIG. 2. The image application 224d may interact with the networking interface 226 to facilitate transmission of the executable code/scripts 224c via the network 250 to the imaging devices 230, 240. The image capture applications 234a and 244a may interact with processors 232 and 242 to execute the code/scripts 224c for imaging devices 230 and 240, respectively, to generate an output. The output of the imaging devices 230, 240 and/or a summary of the execution of the code/scripts 224c may be displayed on the user device 260.

### Example Imaging Device

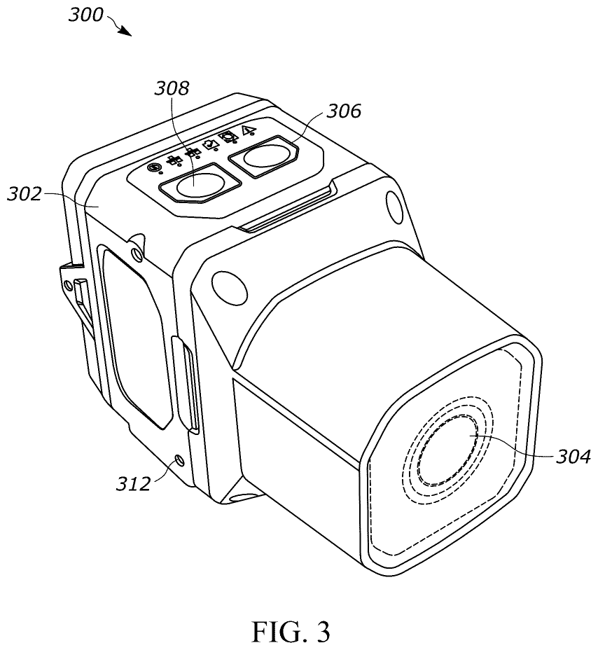

FIG. 3 is a perspective view of an example machine vision imaging device, also called an imaging device, 300 that may be any of the imaging devices 102a-102d, 104a-104d of FIG. 1. The machine vision imaging device may be implemented as an imager for machine vision applications in accordance with embodiments described herein. The machine vision imaging device 300 includes a housing 302, an imaging aperture 304, a user interface label 307, a dome switch/button 308, and mounting point(s) 312. The imaging device 300 may include imaging device operating parameters, e.g., operational settings for the imaging device 300, such as an exposure time, a focal distance, a spatial resolution setting, an aperture opening amount (e.g., exposure amount), shutter speed, a sensor gain amount, parameters related to formatting the image, device information, transport layer settings, triggers, chunk data, lighting, encoders, etc. In some embodiments, an imaging device may have operating parameters that are unique to the imaging device (i.e., custom features). For example, an imaging device 102a may have one or more operating parameters that an imaging device 104a does not have. A description of the imaging device operating parameters may be stored as an XML file or a JSON file in a memory of the imaging device 300, such as the memory 244 in FIG. 2. The operating parameter may be standard feature naming convention (SFNC) features, predetermined features preset features or custom features. SFNC features describe naming conventions and a standard behavioral model for standard features (i.e., operating parameters) of an imaging device. Predetermined features may be user-sets which are used to set the 3D camera for profile or 3D surface acquisition. Preset features may be features that can be created by the user for a specific case. Custom features describe naming conventions for non-standard features that are unique to a type or model of imaging device. For example, a 3D imaging device may include custom features to automatically remove vibration and for custom HDR modes.

The imaging device 300 may transmit the description of the imaging device operating parameters to the server 112 to be used by the server 112 in generating code for controlling the machine vision imaging device 300. The imaging device operating parameters are operable to adjust the configuration of the machine vision imaging device 300 prior to capturing images of a target object and to determine a best optimal set of imaging parameters for performing machine vision applications. The machine vision device 200 may obtain executable code, such as Python code, configuring the imaging device operating parameters, which the machine vision imaging device 300 thereafter executes.

### Example Machine Learning Model

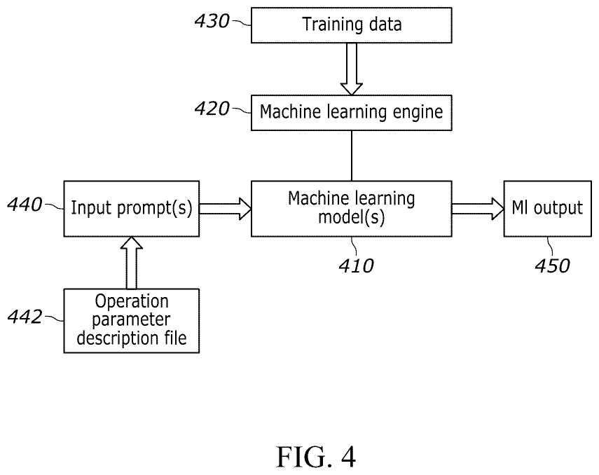

FIG. 4 illustrates a flow diagram for example training and operation of a machine learning model 410 (e.g., the machine learning model 224a), according to some embodiments. The example training and/or operation of the machine learning model 410 may be performed by the server 112 of FIG. 1 and/or processing platform 220 of FIG. 2. In some embodiments, some or all of the machine learning model 410 may be implemented at an imaging device, such as imaging device 230 and/or 240 of FIG. 1.

A machine learning engine 420 may include one or more hardware and/or software components to obtain, create, (re)train, fine-tune, and/or store one or more machine learning models, such as the machine learning model 410. To train the machine learning model 410, the machine learning engine 220 may use training data 430. A server, such as server 112, may obtain and/or have available one or more types of training data 430 (e.g., training data stored in the memory 224 or in an external database). In one aspect, at least some of the training data 430 may be labeled to aid in (re)training and/or fine-tuning the machine learning model 410. During training of the machine learning model 410 by the machine learning engine 420, the machine learning model 410 may be configured to process the training data 430 to learn associations and relationships in the training data 430.

In some embodiments, the machine learning engine 420 updates the training data 430 as needed, e.g., to include new data. Such data may be stored as updated training data 430. Subsequently, the machine learning model 410 may be retrained based upon the updated training data 430, or the new portions thereof, which may cause the machine learning model 410 to improve over time. For example, the machine learning model 410 may improve generating executable code to control imaging devices.

In some embodiments, the machine learning model 410 may be a generative model and/or include generative functionality allowing the machine learning model 510 to generate new content, such as images, text, or other forms of data, that is similar to, or inspired by, existing examples.

In at least some aspects, the machine learning model 410 may generate responses to requests using natural language. In at least some aspects, the machine learning model 510 may generate executable code for an imaging device (e.g., the imaging devices 102a-d, 104a-d) to execute. In some embodiments, the output 450 may include executable code for an imaging device (e.g., the imaging devices 102a-d, 104a-d) to execute. In some embodiments, the code may be Python code. The machine learning model 410 may generate code that includes instructions to configure and/or modify one or more operating parameters of an imaging device. In some embodiments, the machine learning model 410 may generate code to request a status (e.g., temperature) from an imaging device. In some embodiments, an input prompt 440 may be a natural language prompt that includes a requested output image such that the machine learning model 410 may determine a subset of imaging device operating parameters to configure to produce a requested output image. In some embodiments, an input prompt 440 may include a request for more than one imaging device such that the machine learning model 410 generates an additional set of executable code for each additional imaging device. For example, an input prompt 440 may include a request for an imaging device 230 and an imaging device 240. In some embodiments, the request may include a question about the imaging device that cannot be found in an imaging device manual. For example, a request may include questions including questions about the maximum operating temperature of the device, the dimensions of an object and/or the imaging device in millimeters, the weight of the object and/or imaging device in ounces, the maximum input frequency of the I/O interfaces, etc. In some embodiments, text, images, audio, and/or videos may be generated in response to the request. For example, a request of “Show me how to mount the imaging device” may generate a video response showing how to mount the imaging device, text instructions of how to mount the imaging device, images of how to mount the imaging device, and/or audio of how to mount the imaging device.

The present techniques may include language modeling via one or more LLMs wherein one or more models (e.g., deep learning models) are trained by processing token sequences using an LLM architecture. For example, a transformer architecture may be used to process a sequence of tokens. The transformer model may include a plurality of layers including self-attention and feed-forward neural networks. The transformer architecture may enable the model to learn contextual relationships between the tokens, and to predict the next token in a sequence, based upon the preceding tokens. During training, the model is provided with the sequence of tokens and it learns to predict a probability distribution over the next token in the sequence. The training process may include updating one or more model parameters (e.g., weights or biases) using an objective function that minimizes the difference between the predicted distribution and a true next token in the training data.

Alternatives to the transformer architecture may include recurrent neural networks, long short-term memory networks, gated recurrent networks, convolutional neural networks, recursive neural networks, and other modeling architectures.

In some embodiments, the machine learning engine 420 trains the machine learning model 410 using the training data 430 to generate the output 450 based on receiving the input prompt 440. In some embodiments, the input prompt 440 may be a natural language prompt and/or include a natural language query. In some embodiments, the input prompt 440 may be received at a server (e.g., server 112) and/or processing platform (e.g., processing platform 220) implementing the machine learning model 410 or an imaging device (e.g., imaging devices 102a-d, 104a-d, 230, and/or 240). Once trained, the machine learning model 410 may perform operations the input prompt 440 to produce a desired output 450, as discussed above. In one aspect, the machine learning model 410 is loaded at runtime from a memory or external database (e.g., the model 410 loaded by the machine learning engine 420 from the memory 224, or an external database). The server and/or machine learning engine 420 may obtain the input prompt 440 (e.g., from a user device such as user device 260 in FIG. 2), and the machine learning engine 420 may provide the input prompt 440 to the trained machine learning model 410 as an input, for the machine learning model 410 to generate the output 450. In some embodiments, some or all of the functions of the machine learning model 410 may be implemented at an imaging device such as imaging device 102a-d, 104a-d, 230, and/or 240.

The machine learning model 410 may generate code that includes instructions to configure one or more operating parameters of an imaging device. For example, in response to an input prompt “Set the exposure to 5 ms,” the machine learning model 410 may generate code that instructs an imaging device (e.g., one of imaging devices 102a-d, 104a-d) to set its exposure to 5 ms. In some embodiments, the machine learning model 410 may generate code to request a status (e.g., temperature, time, dimensions, frequency of I/O interfaces) from an imaging device. For example, in response to an input prompt “What is the current laser temperature?”, the machine learning model 410 may generate code to query one of imaging devices 102a-d, 104a-d for the laser temperature, and transmit the laser temperature to the platform 220 to be displayed. In some embodiments, an input prompt 440 may be a natural language prompt that includes a requested output image such that the machine learning model 410 may determine a subset of imaging device operating parameters to configure to produce a requested output image. For example, if the natural language prompt is “I want the image to be brighter,” the machine learning model 410 may determine a change in exposure is needed and may generate code instructing an imaging device 230 to modify the exposure.

In some embodiments, an operation parameter description file 442 may be included with input prompt 440 (i.e., retrieval augmented generation). The operation parameter description file 442 may include imaging device operating parameters, e.g., operational settings for the imaging device 300, such as an exposure time, a focal distance, a spatial resolution setting, an aperture opening amount (e.g., exposure amount), shutter speed, an International Standards Organization (ISO) setting, and/or a sensor gain amount. In some embodiments, the operating parameters may be standard feature naming convention (SFNC) features, predetermined features, preset features, or custom features. In some embodiments, the operating parameter description file may be an XML file or a JSON file. In some embodiments, a description of SFNC features (not depicted) may additionally or alternatively included in the input prompt 440. In some embodiments, the input prompt 440 may include example natural language prompts and example sets of executable code corresponding to the example natural language prompts to configure the machine learning model to generate sets of executable code.

### Example Method

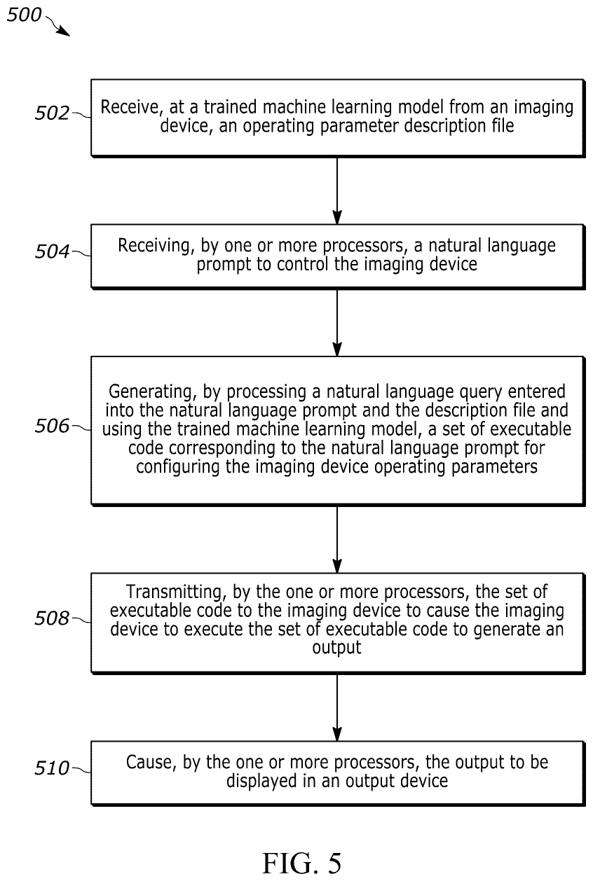

FIG. 5 depicts a flow diagram of an example method 500 for controlling an imaging device. One or more blocks of the method 500 may be implemented as a set of instructions stored on a computer-readable memory and executable on one or more processors. The method 500 may be implemented via one or more local or remote processors such as the processor 222, 232, 242, servers such as the server 112, systems such as the computing environment 100, and/or other electronic or electrical components, which may be communicatively coupled with one another.

At a block 502, a trained machine learning model, such as the model 224a in FIG. 2, may receive an operating parameter description file from an imaging device, such as imaging devices 102a-d and/or 104a-d in FIG. 1. In some embodiments, the imaging device may receive more than one file, including a file describing imaging device-specific information, an imaging device manual and/or user guide, etc. In some embodiments, the trained machine learning model 224a may be a large language model (LLM). In some embodiments, the trained machine learning model may be configured to generate sets of executable code for configuring the imaging device operating parameters by inputting example natural language prompts and example sets of executable code corresponding to the example natural language prompts.

In some embodiments, the operating parameter description file may be an extensible markup language (XML) file. The operating parameters description file may describe operating parameters and/or features of the imaging device. The imaging device operating parameters described in the operating parameter description file may include at least one of a position, a time, a shutter speed, an exposure, a frequency, a resolution, an aperture, etc. In some embodiments, each imaging device in the plurality of imaging devices (e.g., imaging devices 102a-d, 104a-d) may include different operating parameters. In some embodiments, the operating parameters description file may include at least one of standard feature naming convention (SFNC) features, predetermined features, preset features, or custom features (e.g., operating parameters that are unique to an imaging device) that describe the operating parameters of one or more imaging devices. In some embodiments, the trained machine learning model 224a may further receive a file describing imaging device standard feature naming convention (SFNC) terminology. In some embodiments, the trained machine learning model 224a may additionally and/or alternatively further receive imaging device documentation such as a manual, a user guide, etc.

At a block 504, the method 500 may include receiving a natural language prompt to control the imaging device. The natural language prompt may include a natural language query, which may include at least one of a query for respective statuses of a plurality of imaging devices and a query to configure the plurality of imaging devices. In some embodiments, the natural language query includes one or more of a status query (e.g., a query requesting a status from imaging devices 102a-d, 104a-d), a query correlating to adjusting the imaging device operating parameters, an outcome-based query (e.g., a query requesting a specific outcome and/or result from the imaging devices, such as a requested output image), or a query affecting a plurality of imaging devices. In some embodiments, the natural language prompt may include a requested output image. In some embodiments, the natural language prompt may include a question about imaging device capabilities, a request to explain how to operate and/or position the imaging device, etc.

At a block 506, the method 500 may include generating, by processing a natural language query entered into the natural language prompt and the description file and using the trained machine learning model, a set of executable code corresponding to the natural language prompt for configuring the imaging device operating parameters. In some embodiments, the description file and/or SFNC file may be included in the prompt through retrieval augmented generation (RAG). In some embodiments, the generated code may be Python code. In some embodiments, generating the set of executable code corresponding to the natural language prompt may include determining a subset of the imaging device operating parameters to configure to produce a requested output image.

At a block 508, the method 500 may include transmitting the set of executable code to the imaging device to cause the imaging device to execute the set of executable code to generate an output. The imaging device, such as imaging devices 102a-102d, 104a-104d, may receive the code and execute the code. In some embodiments, the output of the imaging device executing the set of executable code includes a status of the imaging device. In some embodiments, the output may include one or more of text, image, audio, and/or video data.

At a block 508, the method 500 may include transmitting the set of executable code to the imaging device to cause the imaging device to execute the set of executable code to generate an output (e.g., an image).

At a block 510, the method 500 may include causing the output to be displayed in an output device. In some embodiments, the method may further include causing a summary of the executed code to be displayed in the output device.

In some embodiments, the method 500 may further include receiving, from one or more additional imaging devices, a respective operating parameter description file for each of the one or more additional imaging devices. The method 500 may include generating, by processing the natural language query entered into the natural language prompt, the description file, and the respective description file for each of the one or more additional imaging devices and using the trained machine learning model, an additional set of executable code corresponding to the natural language prompt for configuring at least one of the one or more additional imaging device operating parameters. The method 500 may include transmitting, by the one or more processors, the additional executable code to the at least one of the one or more additional imaging devices to cause the at least one of the one or more additional imaging device to execute the additional set of executable code.

In some embodiments, the method 500 may further include receiving a second natural language prompt to modify the image. The method 500 may include generating, by processing the second natural language prompt and using the trained machine learning model, a third set of executable code corresponding to the second natural language prompt for modifying the image. The method 500 may include executing the third set of executable code to generate a modified image and causing the output (e.g., the modified image) to be displayed in an output device.

### Additional Considerations

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their respective entireties, for all purposes. Implementations of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean.” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the implementations herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular implementations and applications have been illustrated and described, it is to be understood that the disclosed implementations are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for controlling an imaging device comprising:
receiving, at a trained machine learning model from an imaging device, an operating parameter description file;
receiving, by one or more processors, a natural language prompt to control the imaging device;
generating, by processing a natural language query entered into the natural language prompt and the description file and using the trained machine learning model, a set of executable code corresponding to the natural language prompt for configuring the imaging device operating parameters;
transmitting, by the one or more processors, the set of executable code to the imaging device to cause the imaging device to execute the set of executable code for capturing subsequent image data and/or generating image data for output; and
cause, by the one or more processors, capture of the subsequent image data and/or display of the image data at an output device.

2. The method of claim 1, wherein the natural language query includes at least one of (i) a query for respective statuses of a plurality of imaging devices, (ii) a query to configure the plurality of imaging devices.

3. The method of claim 2, wherein each imaging device in the plurality of imaging devices include different operating parameters.

4. The method of claim 1, further comprising:
receiving, from one or more additional imaging devices, a respective operating parameter description file for each of the one or more additional imaging devices;
generating, by processing the natural language query entered into the natural language prompt, the description file, and the respective description file for each of the one or more additional imaging devices and using the trained machine learning model, an additional set of executable code corresponding to the natural language prompt for configuring at least one of the one or more additional imaging device operating parameters; and
transmitting, by the one or more processors, the additional executable code to the at least one of the one or more additional imaging devices to cause the at least one of the one or more additional imaging device to execute the additional set of executable code.

5. The method of claim 1, wherein the natural language prompt includes a requested output image and wherein generating the set of executable code corresponding to the natural language prompt includes determining, by the trained machine learning model, a subset of the imaging device operating parameters to configure to produce the requested output image.

6. The method of claim 1, wherein the output of the imaging device executing the set of executable code includes a status of the imaging device.

7. The method of claim 1, wherein the output includes an image and further comprising:
receiving, by the one or more processors, a second natural language prompt to modify the image;
generating, by processing the second natural language prompt and using the trained machine learning model, a third set of executable code corresponding to the second natural language prompt for modifying the image;
executing, by the one or more processors, the third set of executable code to generate a modified image; and
cause, by the one or more processors, the output to be displayed in an output device.

8. The method of claim 1, wherein the trained machine learning model is a large language model (LLM).

9. The method of claim 6, further comprising configuring the trained machine learning model to generate sets of executable code for configuring the imaging device operating parameters by inputting example natural language prompts and example sets of executable code corresponding to the example natural language prompts.

10. The method of claim 1, wherein the description file is an extensible markup language (XML) file or a JSON file.

11. The method of claim 2, wherein the imaging device operating parameters include at least one of (i) a position, (ii) a time, (iii) a shutter speed, (iv) an exposure, (vi) a frequency, (vii) a resolution, (viii) an aperture.

12. The method of claim 1, wherein the executable code is Python code.

13. The method of claim 1, wherein the natural language query includes one or more of (i) a status query, (ii) a query correlating to adjusting the imaging device operating parameters, (iii) an outcome-based query, or (iv) a query affecting a plurality of imaging devices.

14. The method of claim 1, further comprising receiving, at the machine learning model, a file describing imaging device standard feature naming conventions (SFNC).

15. The method of claim 1, wherein the operating parameters description file includes at least one of (i) standard feature naming convention (SFNC) features, (ii) predetermined features, (iii) preset features, or (iv) custom features.

16. The method of claim 1, further comprising causing, by the one or more processors, a summary of the executed code to be displayed in the output device.
